(19) United States
(12) Patent Application Publication
(10) Pub. No.: US 2009/0248360 A1
(43) Pub. Date: Oct. 1, 2009

(54) METHOD AND SYSTEM FOR MACHINE CONDITION MONITORING AND REPORTING

(76) Inventor: Mike Garrison, Bixby, OK (US)

Correspondence Address: GREER, BURNS & CRAIN, LTD., Suite 2500, 300 South Wacker Drive, Chicago, IL, 60606, US

(21) Appl. No.: 12/060,712

(22) Filed: Apr. 1, 2008

(51) Int. Cl. G06F 15/00

(52) U.S. Cl. 702/182

(57) ABSTRACT

A method for reporting machine condition, includes monitoring at least one machine function from a plurality of points on the machine and obtaining performance data; transmitting the data to a report generator; operating the report generator to compile the data into at least one report indicative of at least one machine condition and performance factor from the plurality of points; and displaying the at least one report indicative of the at least one function from the plurality of points.

### BACKGROUND OF THE INVENTION

The present invention relates generally to technology used for monitoring the operation of vibrating equipment, such as but not restricted to equipment used for material processing, such as vibrator screen units used for separating or classifying particulate feed material as to size. More particularly, the present invention relates to a system for on-site monitoring, comparison with preset parameters and display of machine functions to facilitate operation and/or maintenance of machines, machine components such as bearings, and support structures.

Vibrator screen units are well known for separating particulate feed material into various size classes. Such units include a pair of separated, generally vertical sidewalls or plates which support at least one and preferably several transversely positioned decks of apertured screening material. When multiple screening decks are provided, the upper screen materials have larger openings than those below. Upon generation of a generally vertical vibrating motion, particles fed to the decks are caused to bounce so that smaller-sized particles fall through the openings in the screen material, and larger-sized particles remain upon the deck. Using multiple decks, operators are able to generate a product of classified material in several size ranges.

Such screen units are designed with a specified amplitude and velocity, which is a function of the configuration of the plates, the size and type of the vibration generating device, the orientation of the plates and/or the screen decks, and fabrication and assembly techniques, among other factors well known in the art of designing and manufacturing such units. As a result, screen units of a particular model typically develop a fairly predictable operating frequency upon operation, with individual units of a particular design developing small variations in operating frequency from the model/design parameters. Over time, the operating frequency of an individual unit often changes, influencing productivity.

In addition, vibrating screen units are typically mounted on concrete and steel structures. Through use, shifting of the underlying substrate and/or deterioration of the structure, over time the machine may not be supported properly, and poor machine performance may result. To date, it has been very difficult to distinguish machine performance problems caused by poor structures from those caused by poor machine condition.

Conventional vibrating screen units are provided with plates made of steel in the range of 0.75 to 1.5 inch thick, which is strong in the axial direction. However, the plates are relatively thin in view of the production loads and work performed. As such, the screen units are susceptible to racking or twisting forces along the Z-axis. Potentially damaging operational forces in vibrator screen units are caused, among other factors, by uneven or misaligned springs, uneven foundation mounts, improper vibrating speed, improperly installed screen decks, and/or worn bushings and imbalanced flywheels on the vibration generator. Due to the wide variety of potential causes for vibrator unit malfunction, it is difficult for the average operator to detect when a unit is not operating according to its design parameters. It is even more difficult for the average operator to accurately diagnose the cause of the malfunction.

Conventional techniques for monitoring plate movement include the fastening of paper throw cards to the plates at designated locations, typically near the inlet and discharge ends of the unit, and near the vibration generator. Ideally the cards are mounted at corresponding locations on each plate at a corresponding end of the unit. However, due to the harsh operational environment of the vibrator unit (quarry, mine, gravel plant, road building site, etc.) and the variations in operator training, very often the cards on each plate at a designated machine are not properly placed for accurate results. An individual applies a pencil or similar marking instrument while attempting to hold his hands steady against the card while the unit is operating, and a pattern is generated by the unit, which varies by the style of unit involved. Typical patterns include ellipses, straight lines and circles. Upon drawing at least one trace or curve, or preferably a series of traces at one monitoring point, the user then moves to a corresponding card at another monitoring point on the machine and produces another trace or set of traces. Next, the traces of the respective plates at the same location are visually compared as to their two-dimensional (X and Y-axes) similarity. If the patterns are angularly skewed, show blurred lines or vertically or horizontally displaced beyond a designated range, the unit is judged to be out of synch, requiring modification of the plates or screen deck fasteners, change of speed of the vibration generating device or the device itself, or other modifications known to skilled practitioners to bring the traced patterns within acceptable degrees of similarity.

While the use of throw cards is the accepted technique for monitoring the operation of vibrator units, a significant drawback of this technique is that it is subjective, one cause being that the pressure applied by individuals varies, influencing the results. Some operators are anxious about standing next to the unit vibrating in the range of 900 rpm. As a result, the pressure applied by the user may vary, as well as the angle of the pencil to the throw card. Further, if the operator's hand moves while marking on the card, or if he shifts his weight or moves his feet, the results will vary. Such variation may apply on a card-to-card basis by a single operator, due to fatigue or subtle variations in stance or pressure at various points on the machine, and such variations increase when operator-to-operator technique is compared. On large-sized vibrator units, some points on the machine are too high to reach when standing, and due to instability, ladders are not placed against vibrating machines. Thus, on larger units, some technically desired sampling points are not practically monitorable and are virtually inaccessible.

To combat this variation on units where access is available, it is recommended that the same individual monitor each plate at each designated point on a particular vibrator unit at a sampling event. Due to this procedure, since the same individual can only monitor one location at a time, the sampling is temporally displaced for each monitoring point on respective plates. Even when the same individual performs the monitoring on a designated unit, the other variables listed above typically combine to create a great degree of subjectivity in the curves or plots generated. As such, many operators rely on specially trained vibrator unit technicians who periodically monitor the units for performance. Such technicians are trained to avoid the above-listed variables in card throw techniques; however while more accurate than average, their throw card data is still somewhat subjective. Also, as may be appreciated, there is limited availability of such technicians, who are also trained to diagnose the causes of substandard throw card curves or plots and their remedies.

Another drawback of the conventional throw card technique is that the monitoring is two-dimensional only, in the X and Y-axes. Other than when a portion of a drawn curve is missing in one location or portion, indicating lateral motion of the unit, this conventional technique is incapable of accurately monitoring side-to-side (Z-axis) movement of the unit. Such movement is an important indicator of plate asynchrony, due to the susceptibility of the plates to damage or accelerated wear caused by imbalanced forces acting in this direction. In view of the many causes for variation, it is estimated that as much as 70-80% of conventional throw card data is faulty.

In an effort to objectify the monitoring of plate movement using throw cards, some vibrator unit technicians have explored the use of accelerometers placed at desired unit monitoring locations. The accelerometers are positioned to monitor movement in the X and Y-axes in similar locations to the placement of throw cards, and are connected to monitoring computers which plot appropriate curves. On a typical screen unit, pairs of accelerometers are placed at respective corners of the unit, totaling four pairs. On some screen units, those typically having wider spacing between the plates, accelerometers are mounted for measuring movement in the Z-axis. Accelerometers have also been placed to monitor the bearing condition of the vibration generator. However, while this technique generates more objective data, conventional monitoring equipment has been designed to monitor data from one point on one plate at a time, and comparisons are typically restricted to a two-dimensional format (X and Y-axes). Also, due to the limitations of conventional monitoring equipment, movement data in the Z-axis was only available for a respective end (input and discharge) of the screen unit, rather than monitoring lateral movement of the respective plates.

While the implementation of accelerometers as discussed above shows promise in obtaining more objective and reliable vibrator unit performance data, the performance of vibrator screen units is very dynamic, and changes constantly with the volume and or type of material being screened. Thus, even the above-described technique involves inherent variability.

### BRIEF SUMMARY OF THE INVENTION

The above-identified drawbacks are addressed and overcome by the present machine condition monitoring and report system, by which machine operators and/or owners are provided on-site, real-time reports of machine condition through monitoring multiple points on the machine. In the context of this application, “real-time” is defined as a monitoring period sufficient to obtain data from all monitored machine points. While the length of the monitoring period may vary to suit the application, a one hour period from first to last data acquisition is contemplated. Once data at multiple locations is simultaneously displayed, operators are able to determine if one location is operating beyond preset parameters compared to other locations. Thus, corrective action can be taken at the location displaying erratic behavior. Similarly, when machine support structure is monitored, the condition of the structure is also displayed. Furthermore, machine components such as bearings can similarly be monitored by comparing monitored parameters, such as decibels, to preset parameters.

The monitoring is preferably employed using at least one and preferably two transducers such as accelerometers connected to a handheld processor or central processing unit (CPU) with a display screen. Monitoring is conducted in the X, Y and Z axes at each machine monitoring location. The data from the CPU is then transmitted to a separate computer which displays a report including both appropriate performance curves and textual data for multiple monitored locations.

More specifically, a method for reporting machine condition, includes monitoring at least one machine function from a plurality of points on the machine and obtaining performance data; transmitting the data to a report generator; operating the report generator to compile the data into at least one report indicative of at least one machine condition and performance factor from said plurality of points; and displaying said at least one report indicative of said at least one function from said plurality of points.

In another embodiment, a method of measuring the integrity of a structure under an operating machine generating movement includes monitoring at least one of machine movement and structural vibration in all three of the X, Y and Z axes at multiple locations on the machine; generating data representative of the machine movement; transmitting the data to a report generator; and the report generator displaying data simultaneously for all the locations.

In another embodiment, a method of measuring machine component condition, includes monitoring machine component operation by collecting operational data; displaying the monitored data; displaying a preset value of a parameter reflective of the monitored data; and displaying the monitored data and the preset value in real-time.

### BRIEF DESCRIPTION OF THE SEVERAL VIEWS OF THE DRAWINGS

FIG. 1 is a front perspective view of a vibrator screen unit suitable for use with the present monitoring system;

FIG. 2 is an enlarged fragmentary perspective view of the machine of FIG. 1 shown being monitored for machine condition using the present system;

FIG. 3 is a front elevation of a handheld CPU connected to a computer for use with the present system;

FIG. 4 is a schematic representation of a report displayed by the computer connected to the CPU in FIG. 3 displaying real-time images of machine operation at multiple locations;

FIG. 5 is a Data Collection Guide for receiving and displaying input data collected by the monitoring probes to achieve the report of FIG. 4; and

FIG. 6 is a schematic representation of a report of bearing condition used in the present method.

### DETAILED DESCRIPTION OF THE INVENTION

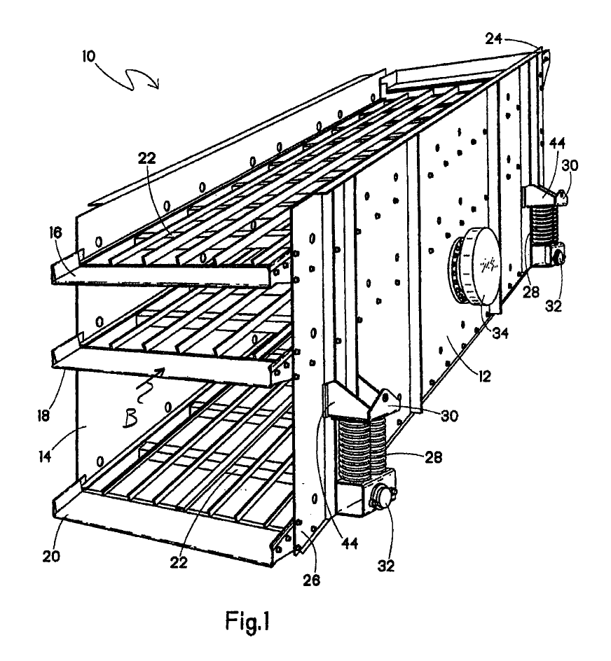

Referring now to FIG. 1, a vibrating unit of the type suitable for use with the present system is generally designated 10 and is depicted as a vibrator screen unit; however it will be appreciated that other types of vibrating equipment or machinery operating on fixed or portable foundations or other support structures are considered to benefit from the present system. As is well known in the art, the vibrator unit 10 includes a first sidewall or plate 12 and a second sidewall or plate 14 disposed in spaced, parallel orientation to the first plate and being separated by at least one transversely disposed screen deck 16. Most such units 10 are provided with multiple screen decks, here depicted as second and third decks 18 and 20 respectively. The uppermost screen deck 16 has a relatively coarser mesh screen fabric or larger apertures. Progressing toward the third deck 20, the mesh pattern becomes finer for retaining relatively smaller particles. The selection of mesh sizes for the decks 16, 18 and 20 is a function of the product material desired by the operator. Transverse support bars 22 are attached to inside walls of each plate 12, 14, support the screen decks 16, 18 and 20 and also maintain spacing between the plates.

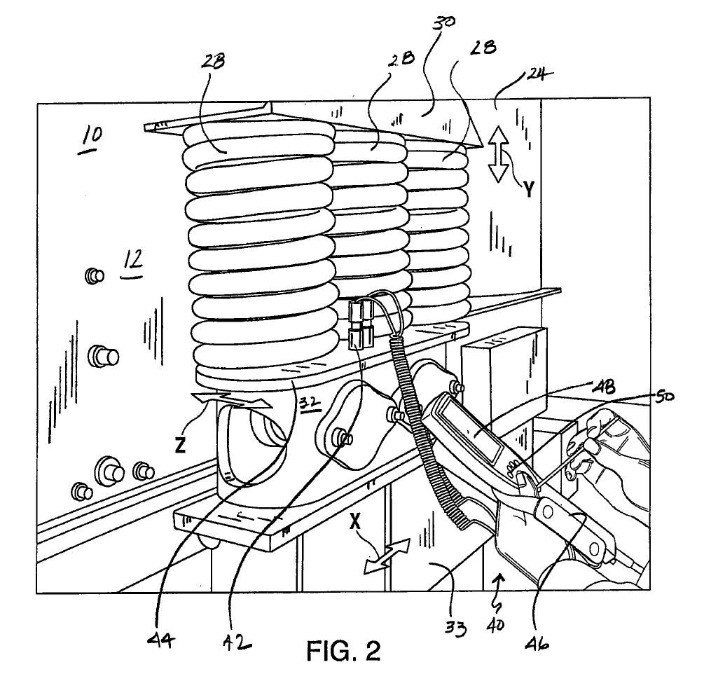

The unit 10 has a feed end 24 and a discharge end 26, with the feed end typically being disposed at a higher elevation than the discharge end to promote gravity flow of classified particulate material. At least one coiled compressible spring 28 is located adjacent the corresponding feed and discharge ends 24, 26 of each plate 12, 14 to provide a resilient suspension at each of the four corners of the unit 10. The springs 28 are typically provided in clusters of at least two and are disposed between upper mounting points or flanges 30 affixed to the corresponding plates 12, 14, and lower mounting points or flanges 32 are connected to a stationary machine mount structure or foundation 33 (FIG. 2) or alternatively a mobile processing unit, so that the unit 10 is resiliently mounted to the substrate. A motion generator, such as a powered flywheel, eccentric or the like is designated 34 and generates a cyclical movement of the unit 10 upon energization. Depending upon the type and construction of the unit 10, the movement created by the motion generator 34 causes the unit 10 to define a linear, elliptical or circular cyclical movement.

Given the relatively narrow spacing of the plates 12, 14 compared to the length of the unit 10, and the transverse support bars 22 being the main structural support of the unit, it will be understood that the unit is subject to vertical and/or horizontal racking or torque forces upon stress loading, particularly when large-sized and/or large volumes of particulate feed material are deposited upon the uppermost deck 16. The operational life of the unit 10 is in part a function of the degree of misalignment or disparity in movement between the plates 12, 14.

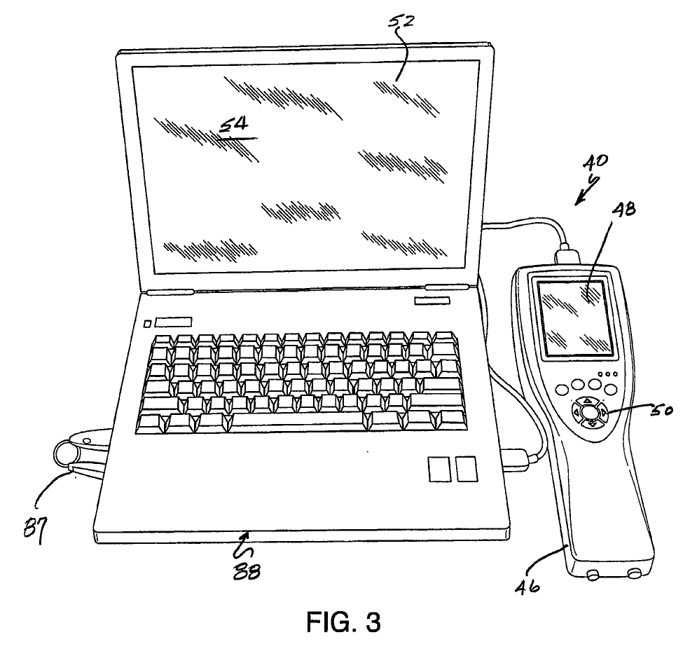

Referring now to FIGS. 2 and 3, the present stress monitoring system is generally designated 40 and includes at least one motion sensor 42, preferably an accelerometer; however other motion sensors are contemplated, disposed at least one monitoring point 44 on the unit 10. Preferably, the monitoring points 44 are identical corresponding locations on each of the plates 12, 14, and are located at the feed and discharge ends 24, 26 of each plate. While at least one motion sensor 42 is provided, it is preferred that at least two such sensors are disposed at each monitoring point 44 to monitor the X and Y-orthogonal axes, and most preferably three such sensors are disposed at each monitoring point 44 to respectively measure movement in the X, Y and Z-axes. Thus, in a preferred system 40 there are at least eight and preferably twelve total sensors 42. It is also contemplated that the sensors 42 are portable and are moved about the machine 10 to monitor specific points indicative of movement in the X, Y and Z-axes. It is also contemplated that as seen in FIG. 2. a designated pair of sensors 46 is positioned to measure movement in the X-axis, then the sensors are sequentially moved to different points on the machine 10 at the monitoring point 44 to measure movement in the Y and Z-axes.

The sensors 42 are connected to a processor 46 (FIG. 2) also referred to as a Central Processing Unit (CPU) such as a computer, server or similar unit capable of receiving, manipulating and transmitting data. Suitable software is available from Metso Automation (www.metsoautomation.com) under the designation Sensodec™. In the preferred embodiment, the processor 46 is a hand-held unit provided with a display 48 for providing visually detectable performance curves of the unit 10 at the monitoring points 44. Also provided is a keypad 50 through which an operator may access various monitored functions. While other units are contemplated, the preferred processor 46 is the Leonova (www.leonovabyspm/economy/index.html), manufactured by SPM Instrument AB Sweden (www.spinstrument.com).

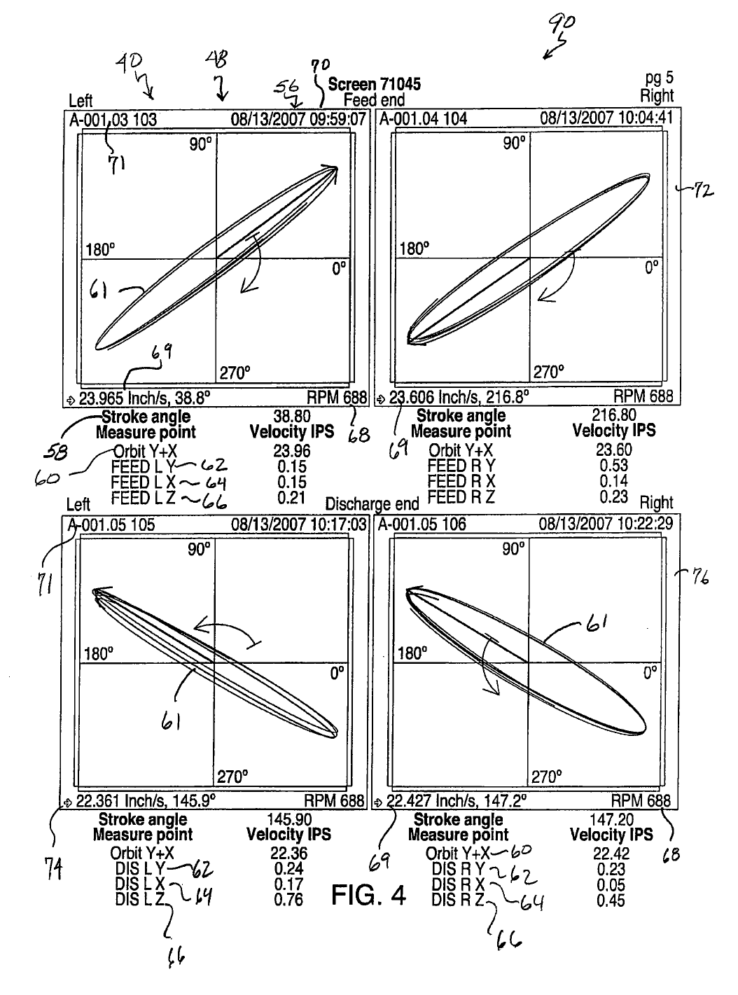

As seen in FIGS. 2 and 3, the processor 46 collects and stores data from the various positions of the sensors 42 at each of the monitoring points 44, but displays only one such point at a time. Thus, it is preferably connected to a conventional computer 52 having a larger display screen 54. By using the larger display screen 54, data received by the processor 46 from several monitored points 44 can be observed simultaneously as seen in FIG. 4, enabling real-time evaluation of machine performance. While the nature and extent of the displayed data may vary to suit the application, type of machine, machine structure or monitored component, it is preferred that a data display 56 is provided for each monitored point 44 (here FEED Left), stroke angle 58, referring to the amount of displacement in each vibrational cycle taken by placing the sensors 42 at the end of the mechanism beam B along the longitudinal center line of the unit (FIG. 1), the orbit Y+X 60 obtained by orienting the sensors 42 in both the X and Y-axes, and which is indicated textually in units of velocity or inches/second (here 23.96IPS) and also graphically by the elliptical orbit 61 resulting from a combination of the X and Y values. In addition to displaying the above-listed machine parameters, the structure 33 is measured in terms of Y-axis displacement in inch/second 62, here FEED LY referring to the feed end left Y-axis, indicated in distance units as shown as 0.15 in/second, X-axis displacement 64, here FEED LX referring to feed end left X-axis, shown as 0.15 in/sec., Z-axis displacement 66 here FEED LZ referring to the feed end Z-axis, shown as 0.21 in/sec., as well as machine speed 68 in rpm (here 688 rpm), measured by the frequency of the vibrations monitored by the motion sensors 42, displacement or ‘g’ forces in inches/second 69 (usually equals Y+X orbit 60) and the date and/or time 70. The latter time stamp value 70 is employed to confirm the monitoring period as being “real-time”. Machine identification information is optionally provided at 71.

Referring again to FIG. 4, preferably similar graphic and textual displays of machine parameters are repeated for the four corners of the machine 10, specifically the Feed Right position 72, the Discharge Left position 74 and the Discharge Right position 76. The system 40 features the displays 56, 72, 74 and 76 simultaneously depicting machine performance from the four monitored points 44 taken in the real-time period described above to provide a reasonably current “snapshot” of machine operation from several monitoring points. As will be described in greater detail below, by comparing the values at each monitoring point 44, the operator can determine whether the machine 10 is operating properly.

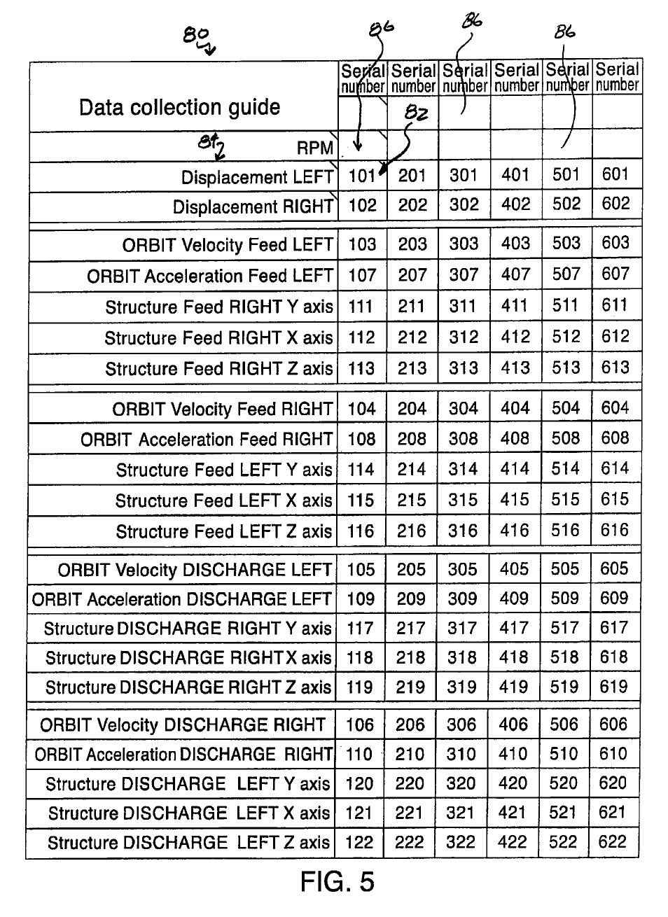

Referring now to FIG. 5, the data arrangement of FIG. 4 is constructed by manipulation of data collected by the processor 46. To organize and transfer the data received from the processor 46 to the display 48 on the computer 52, a Data Collection Guide 80 is provided, having a series of codes 82, each of which is associated with a designated machine function or parameter. For example, for each machine 10, a series of the codes 82 are consecutively numbered 101-122, with each code number associated with one of the parameters defined on the displays 56, 72, 74, 76 shown in FIG. 4. The parameter column is designated 84 and the code column for each machine is designated 86. Data from multiple machines can be monitored by numerically distinguishing the various machines. In the preferred embodiment, the first of three digits of each code is associated with a different machine (100 series, 200 series, 300 series, etc. each in a separate column 86 refer respectively to machines 1, 2 and 3).

Once the code designations 82 are made, data collected by the processor 46 at each collection point 42 is associated with the appropriate code in the processor. It will be seen that both machine parameters such as Displacement LEFT (101), ORBIT Velocity Feed LEFT (103) are monitored with support structure measurements such as Structure Feed RIGHT Y axis (111), Structure Feed RIGHT X axis (112), etc. Also, it is preferred that the machine velocity codes (103, 104, 105 and 106) for each corner of the machine 10 are recorded in a designated order for more accurate results. Similarly, the ORBIT Acceleration data is also recorded in order (107, 108, 109, 110), as is the structural parameter data (112, 113, 114, 115, 116, 117, etc.). Another advantage is that the order of the data entry facilitates the transfer and entry of the data into a spreadsheet program, such as Microsoft EXCEL® spreadsheets or the like, as is known in the art. It will also be seen that at the top of the Guide 80, blanks are preferably allocated for machine serial numbers to allow customers to evaluate particular machines repeatedly over time to compare data.

Referring now to FIG. 3, the processor 46 is connected to the standard computer 52 such as a laptop. As is known in the art, a software key 87, such as a Condmaster Nova USB or the like available from SPM Instrument AB (www.spinstrument.com/products/condmaster), is employed to facilitate data transfer. Using software loaded onto the computer 52, such as Condmaster Nova, also available from SPM Instrument AB (www.spinstrument.com/products/condmaster), recorded monitored data is transmitted from the processor 46 to the computer 52. Each coded data point (101, 102, etc.) is transferred as a file. Files may be renamed by the operator or automatically by the software to allow the data to be associated with the designated machine parameters in column 84 as ultimately displayed in the report of FIG. 4. As used herein, the software on the computer 52 used to receive data and generate the report of FIG. 4 is designated a report generator 88, and includes both the Condmaster Nova as well as the spreadsheet (Excel®) programs.

Referring again to FIG. 4, the display 48 serves as a report 90 of multiple monitored locations, including machine performance and underlying structural condition as expressed by machine performance and/or monitoring of the particular points of the structure 33. Note that the report 90 includes both performance curves, shown as elliptical orbit data, as well as textual performance information for each of the monitored points 44.

For evaluating machine performance, stroke angle 60 is compared between the left and right sides of the machine. A deviation of greater than 5% in monitored stroke angle between sides of the machine 10 is considered excessive and reflects incorrect operation of the machine. Since the direction of the stroke angle 58 on the 360° quadrant varies with the monitoring point 44, comparison is equalized by comparing the angular deflection from the nearest reference point to obtain a comparison value. The displayed degree has subtracted from it the nearest standard degree value (0°, 90°, 180°, 270°) that is the next lower value than the displayed value. Thus, in DIS Right, the displayed angle of 147.2° is subtracted from 90° to obtain a reading of 57.20°, which is compared with the calculated reading of 55.90° for DIS Left. Similarly, the FEED Left and Right values of 38.80° and (216.3−180=36.8) are outside the acceptable 5% range.

Another compared value for comparing screen performance at respective sides of the machine 10 is velocity, measured in inches/second. A deviation of velocity of greater than 2% between monitored sides of the machine 10 is considered excessive and reflects incorrect operation of the machine. It is seen at FEED Left the velocity is 23.965 in/sec. and at FEED Right 23.606. Since these values are within the accepted range of 2% of each other, the machine 10 is in proper operating condition.

The machine 10 cannot operate correctly on an incorrect structure 33, but the machine can operate incorrectly on a correct support, for example due to incorrect speed. As the customer makes changes to feed material, the weight of the machine 10 changes, and further as material flows through the machine, the machine weight changes. But if the structure moves excessively, machine malfunctions will follow. Also, structural failures cause excessive deflection in the machine 10, resulting in machine malfunction or failure.

Following ISO Standard 2372 for large moving machines on a fixed structure, the preferred maximum allowable structural movement is 0.6 IPS (Inch Per Second) or 15.2 mm/sec measured in velocity. For example, in the displays 56, 72, 74 and 76 shown in FIG. 4, FEED LY is 0.15, FEED RY is 0.53, DIS LY is 0.24 and DIS RY is 0.23. Thus, all monitored points shown in FIG. 4 are within an acceptable variation range.

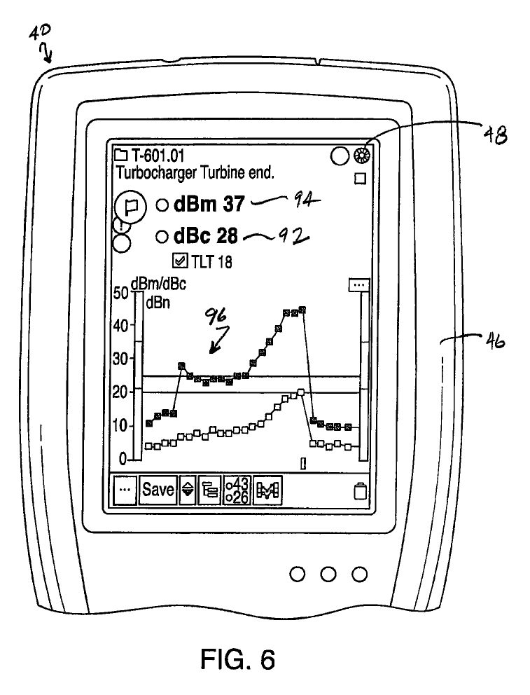

It has been found that for evaluating structural condition, any movement in any axis (X, Y or Z) which is greater than 0.6 IPS (15.25 mmPS) measured in velocity fails that particular monitored point. Thus, for the machine being reported on in the report 90, the DIS LZ value of 0.76 indicates that the structure 33 is failing at that monitored location and requires examination for defects. Referring now to FIG. 6, the present method is also useful in indicating condition of machine components, including but not restricted to bearings. Transducers (not shown) as are known in the art are mounted to the machine 10 in locations adjacent bearings to be monitored. As in the case of the motion sensors 42, the transducers are connected to the processor 46. The processor 46 processes shaft size and operational RPM to determine base operational level (dBc) 92. In other words, the dBc is a parameter reflective of the transducer supplied data, and a preset or preferred value is displayed at 92. Data from the transducer measures operational bearing condition (dBm) 94. The dBM value is displayed graphically at 96 as well as textually. It will be understood that the displays 92, 94 and 96 can be viewed either on the processor 46 or on the computer 52. By visually comparing the difference between the dBc and dBm values, the bearing condition can be quickly determined.

Thus, the present method and system for machine monitoring provides a visual report of machine condition which simultaneously displays machine operation at several points in real-time. In addition to displaying specified parameters of machine and/or machine component operation, the underlying support structure is monitored and displayed in the report so that defects can be readily identified.

While specific embodiments of the present method and system for machine condition monitoring and reporting have been shown and described, it will be appreciated by those skilled in the art that changes and modifications may be made thereto without departing from the invention in its broader aspects and as set forth in the following claims.

What is claimed is:

1. A method for reporting machine condition, comprising:
monitoring at least one machine function from a plurality of points on the machine and obtaining performance data;
transmitting said data to a report generator;
operating said report generator to compile said data into at least one report indicative of at least one machine condition and performance factor from said plurality of points; and
displaying said at least one report indicative of said at least one function from said plurality of points.

2. The method of claim 1 wherein said machine condition and performance factors include at least one of orbit, velocity, stroke angle, ‘g’ force, structural evaluation and bearing condition.

3. The method of claim 1 wherein said displaying of said report takes the form of a combination of graphical and numerical formats representative of real-time performance of the machine based on an accumulation of the data.

4. The method of claim 1 further including assigning codes to each said parameter prior to transmitting said data to said report generator.

5. The method of claim 4 further including converting said codes to parameter names prior to displaying said report.

6. The method of claim 1 wherein said machine is a vibrating screen, said monitoring step includes the use of at least one portable accelerometer obtaining data from at least four locations on the machine.

7. The method of claim 6 wherein said data includes at least one of machine velocity, stroke angle, displacement and acceleration, and said at least one accelerometer transmits machine data to a processor which generates comparable performance curves from each location, and said report generator generates a display for each said location and displays data for multiple locations at said displaying step.

8. The method of claim 7 including evaluating performance curves from diagonally opposite corners of the machine as indicative of structural condition.

9. The method of claim 7 wherein said performance curves display machine movement along the X, Y and Z axes.

10. The method of claim 7 wherein said report generator generates multiple curves simultaneously which are representative of an accumulation of said data from said at least one accelerometer.

11. The method of claim 6 wherein said data is obtained in an order of Left Feed, Right Feed, Left Discharge, Right Discharge.

12. The method of claim 1 wherein said machine condition is bearing function, and said monitoring function is performed by transducers mounted near machine bearings, and decibels are monitored (dBM) and compared against a preset decibel level (dBC) and said monitored and compared data are displayed at said displaying step.

13. A method of measuring the integrity of a structure under an operating machine generating movement, comprising:
monitoring at least one of machine movement and structural vibration in all of the X, Y and Z axes at multiple locations on the machine;
generating data representative of said machine movement; transmitting said data to a report generator; and
said report generator displaying data simultaneously for all said locations.

14. A method of measuring machine component condition, comprising:
monitoring machine component operation by collecting operational data;
displaying the monitored data;
displaying a preset value of a parameter reflective of the monitored data; and
displaying the monitored data and the preset value in real-time.

15. The method of claim 14 wherein said displaying of the data is graphical and textual.
